(19) United States
(12) Patent Application Publication
(10) Pub. No.: US 2008/0285580 A1
(43) Pub. Date: Nov. 20, 2008

(54) ROUTER APPARATUS

(75) Inventor: Kazuaki YOTSUMOTO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/119,992

(22) Filed: May 13, 2008

(30) Foreign Application Priority Data
May 14, 2007 (JP) 2007-128469

(51) Int. Cl. H04L 12/56

(52) U.S. Cl. 370/412

(57) ABSTRACT

A router apparatus allocates a queue in a storage device and transmits transmission-target data after temporarily storing the transmission-target data in the queue. The router apparatus determines whether the size of a usable data area assigned to the queue is equal to or greater than a threshold, and supplements, on the basis of the determination, the data area of the supplementation-target queue having the usable data area whose size is smaller than the threshold with a data area of a queue other than the supplementation-target queue.

### CROSS-REFERENCE TO RELATED APPLICATIONS

This application is related to and claims priority to Japanese patent application no. 2007-128469 filed on May 14, 2007 in the Japan Patent Office, and incorporated by reference herein.

### BACKGROUND

1. Field

The embodiments of the present invention relate to router apparatuses.

2. Description of the Related Art

In the recent network society, a loss in business resulting from a network failure or a system down is immeasurable. Router apparatuses installed in a backbone network are required to continuously operate for 24 hours a day, 365 days a year. Accordingly, especially regarding router apparatuses for companies and carriers that are required to be highly reliable and to carry out secure operations, the fault tolerance and the reliability of router apparatuses or of networks are reinforced to deal with unexpected hardware failures by a redundant configuration of duplication of router apparatuses.

Japanese Unexamined Patent Application Publication No. 2005-323231 discloses a technique that improves the communication speed by determining whether or not to store a communication packet in a queue on the basis of information contained in a header of the communication packet and a state of the queue allocated in a router apparatus.

However, the duplication of router apparatuses for the purpose of reinforcement of the fault tolerance and the reliability undesirably wastes resources and undesirably limits installable places due to cost or operational conditions.

### SUMMARY

According to one aspect of an embodiment of the invention, a router apparatus includes a determining unit that determining whether or not the size of a usable data area assigned to the queue is equal to or greater than a threshold, and a supplementing unit supplementing, on the basis of the result determined by the determining unit, the data area of the supplementation-target queue having the usable data area whose size is smaller than the threshold with a data area of a queue other than the supplementation-target queue.

In the other aspect of an embodiment of the invention, a queue supplementing method includes determining whether or not the size of a usable data area assigned to the queue is equal to or greater than a threshold, and supplementing, on the basis of the result determined at the determining, the data area of the supplementation-target queue having the usable data area whose size is smaller than the threshold with a data area of a queue other than the supplementation-target queue.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a functional block diagram showing a configuration of a packet transmission system according to an embodiment of the present invention;

FIG. 2 is a diagram showing an example of a data structure of a queue management table;

FIG. 3 is a diagram showing an example of a data structure of a queue optimization parameter;

FIG. 4 is a diagram illustrating queues and a buffer memory of a router apparatus;

FIG. 5 is a diagram showing an example of an operation performed in queues having extra memory capacities;

FIG. 6 is a diagram showing a queue optimization parameter calculation model;

FIG. 7 is a diagram illustrating a reduction of memory capacities of queues;

FIG. 8 is a diagram illustrating a merger of similar queues;

FIG. 9 is a flowchart showing a queue optimization parameter recalculation process performed by a QoS managementQoS management unit according to an embodiment of the present invention;

FIG. 10 is a flowchart showing a memory capacity supplementation process performed by a QoS managementQoS management unit according to an embodiment of the present invention; and

FIG. 11 is a diagram showing a hardware configuration of a computer installed in a line blade shown in FIG. 1.

### DETAILED DESCRIPTION OF THE PREFERRED EMBODIMENTS

A router apparatus according to an embodiment of the present invention will be described in detail with reference to the accompanying drawings.

An embodiment of a router apparatus will be described first. The router apparatus according to the embodiment allocates a queue having a data area of a predetermined memory capacity in a storage device, such as a memory, and transmits transmission-target data after temporarily storing the transmission-target data in the queue. When an error occurs in a hardware including a storage device, the router apparatus according to the embodiment determines whether or not the size of a usable data area assigned to the queue is equal to or greater than a threshold in response to the occurrence of the error. Based on the determination result regarding the size of the data area, the router apparatus according to the embodiment dynamically supplements a deficient data area of a queue, whose usable data area is determined to be smaller than the threshold, with a data area of another queue.

When a queue not having a sufficient data area is caused in response to occurrence of an error, the router apparatus according the embodiment dynamically supplements the deficient data area with a data area of another queue. Thus, even if a failure in part of hardware results in a system error, the router apparatus according to the embodiment can continuously operate without halting the system to reconstruct the memory structure.

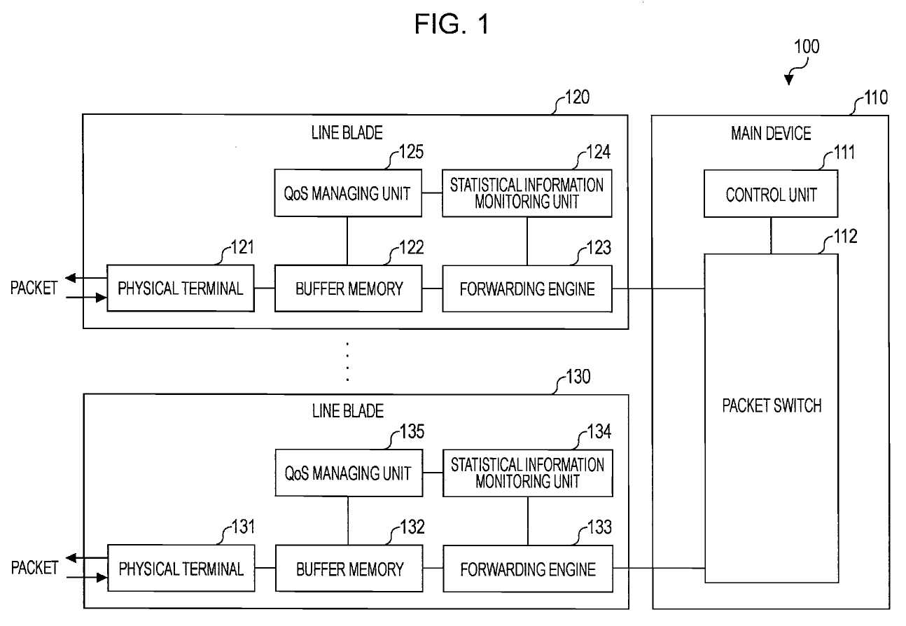

A configuration of the router apparatus according to the embodiment will now be described. FIG. 1 is a diagram showing a configuration of a router apparatus according to the embodiment. As shown in FIG. 1, a router apparatus 100 includes a main device 110 and line blades 120 and 130. Although FIG. 1 shows only two line blades 120 and 130 for ease of explanation, a router apparatus may include three or more line blades.

Upon receiving a packet from the line blade 120 or 130, the main device 110 transmits the packet to a destination line blade of the received packet. The main device 110 has a control unit 111 for controlling the main device 110, and a packet switch 112 for switching a packet-transmission destination in response to a control command fed from the control unit 111.

The line blade 120 has a physical interface 121, a buffer memory 122, a forwarding engine 123, a statistical information monitoring unit 124, and a quality-of-service (QoS) managing unit 125. Since it is assumed that the line blades 120 and 130 have an identical configuration in this embodiment, the description will be given only for the line blade 120 and the description of the line blade 130 is omitted. The physical interface 121, the buffer memory 122, the forwarding engine 123, the statistical information monitoring unit 124, and the QoS management unit 125 of the line blade 120 correspond to a physical interface 131, a buffer memory 132, a forwarding engine 133, a statistical information monitoring unit 134, and a QoS management unit 135 of the line blade 130, respectively.

The physical interface 121 transmits and receives packets to and from an external apparatus, not shown in FIG. 1. In addition, the buffer memory 122 has a plurality of queues, each having a predetermined data area or a predetermined memory capacity, and temporarily stores packets in each of the corresponding queues.

The forwarding engine 123 outputs a packet to the packet switch 112 of the main device 110. The forwarding engine 123 also supplies the buffer memory 122 with a packet fed thereto from the packet switch 112.

The statistical information monitoring unit 124 is a processing unit that counts the length of transmission-target packets for each queue allocated in the buffer memory 122 and generates statistical information indicating a ratio of packets output from each queue to a bandwidth. The statistical information will be described in detail later. The statistical information monitoring unit 124 supplies the generated statistical information to the QoS management unit 125.

The QoS management unit 125 sorts packets accumulated in the buffer memory 122 into many queues classified by parameters, such as a priority and a transmission port, to perform scheduling and then transfers the packets to neighboring router apparatuses.

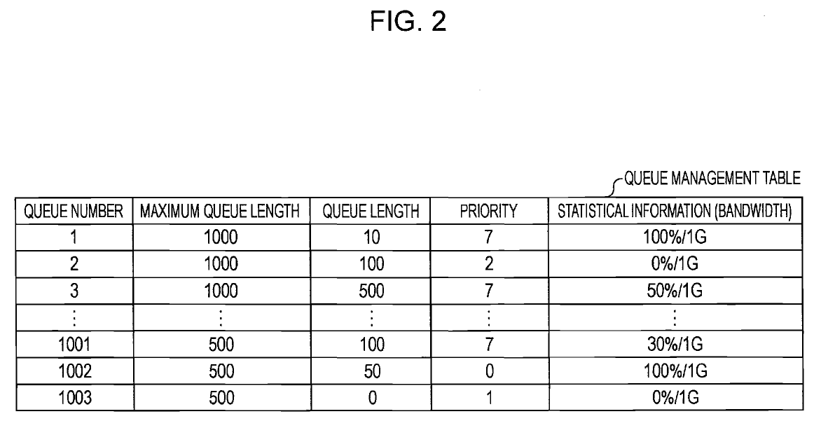

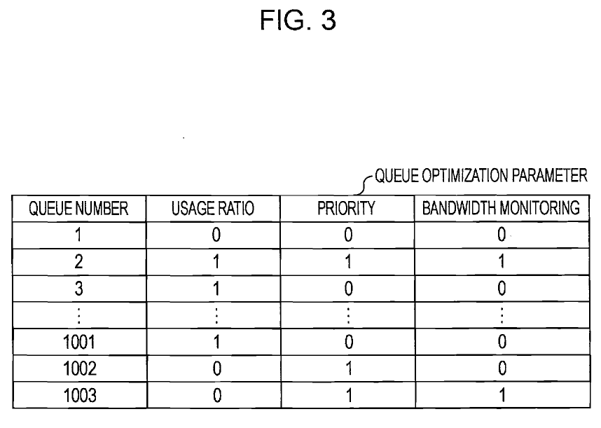

The QoS management unit 125 stores a queue management table and a queue optimization parameter. The QoS management unit 125 supplements a deficient memory capacity of a queue with a memory capacity of another queue on the basis of the queue management table and the queue optimization parameter. FIG. 2 is a diagram showing an example of a data structure of the queue management table. FIG. 3 is a diagram showing an example of a data structure of the queue optimization parameter.

As shown in FIG. 2, the queue management table stores a queue number for identifying each queue, a maximum queue length indicating a maximum capacity of the queue that data is storable, a queue length indicating a data capacity of data stored in the queue, a priority of the queue, and statistical information indicating a usage ratio of a bandwidth assigned to the queue. Meanwhile, a lager queue priority value indicates a higher priority.

For example, a queue corresponding to the queue number “1” has a maximum queue length of “1000”, a queue length of “10”, a priority of “7”, and statistical information of “100%/1G”. Here, the statistical information of “100%/1G” indicates 100% of a 1G bandwidth assigned to the queue is used.

The description will now be given for FIG. 3. The queue optimization parameter stores a queue number for use in identification of a queue, a usage ratio of a data area assigned to the queue, a priority of queue, and bandwidth monitoring information. A value “1” or “0” is stored in the usage ratio column, the priority column, and the bandwidth monitoring column.

A value “1” stored in the usage ratio column indicates that the usage ratio of the data area assigned to a corresponding queue is high and packets are accumulated in the queue. Queues having a higher data area usage ratio and storing accumulated packets are registered as candidates of reduction or merger targets. On the other hand, a value “0” stored in the usage ratio column indicates that the usage ratio of the data area assigned to the corresponding queue is low and packets are not accumulated in the queue.

A value “1” stored in the priority column of the queue optimization parameter indicates that the priority of a corresponding queue is low. Queues with the low priority are registered as candidates of reduction or merger targets. On the other hand, a value “0” stored in the priority column indicates that the priority of the corresponding queue is high.

A value “1” stored in the bandwidth monitoring column indicates that the usage ratio of a bandwidth assigned to a corresponding queue is low. Queues with the low bandwidth usage ratio are registered as candidates of reduction or merger targets. On the other hand, a value “0” stored in the bandwidth monitoring column indicates that the usage ratio of a bandwidth assigned to the corresponding queue is high.

Each value stored in the usage ratio column, the priority column, and the bandwidth monitoring column described above is determined and calculated on the basis of the queue management table shown in FIG. 2. A method for determining the values will be described in detail later.

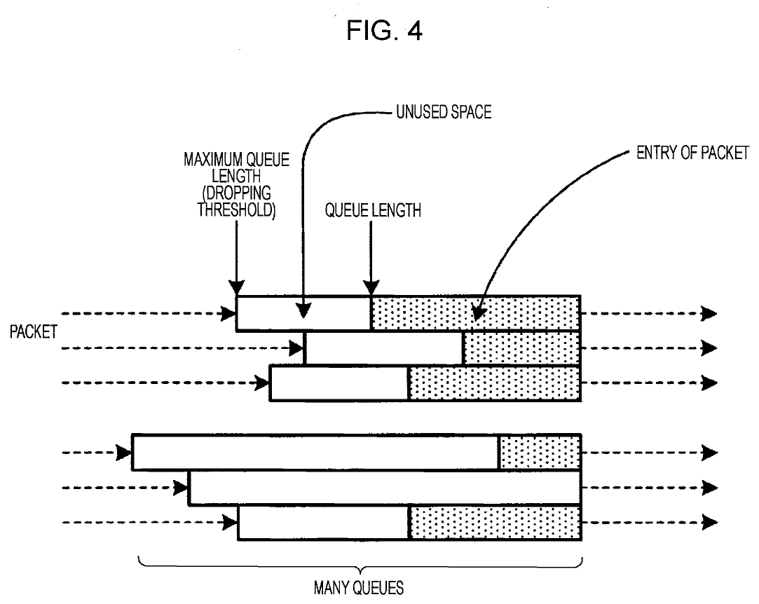

Queues and a buffer memory of the router apparatus 100 will now be described. FIG. 4 is a diagram illustrating queues and a buffer memory of a router apparatus. As shown in FIG. 4, a memory capacity assigned to each queue is defined by the maximum queue length registered in the queue management table shown in FIG. 2. Meanwhile, the maximum queue length corresponds to a threshold for determining whether packets are to be dropped or not. If an actual queue length exceeds the maximum queue length, or the memory capacity, packets corresponding to the queue are dropped. This operation is referred to as a “tail drop operation”. As having such a mechanism, the large-scale router apparatus 100 having many queues shown in FIG. 4 prepares many spaces not storing packets in the buffer memory 122, namely, many unused spaces in the buffer memory 122 during a normal operation.

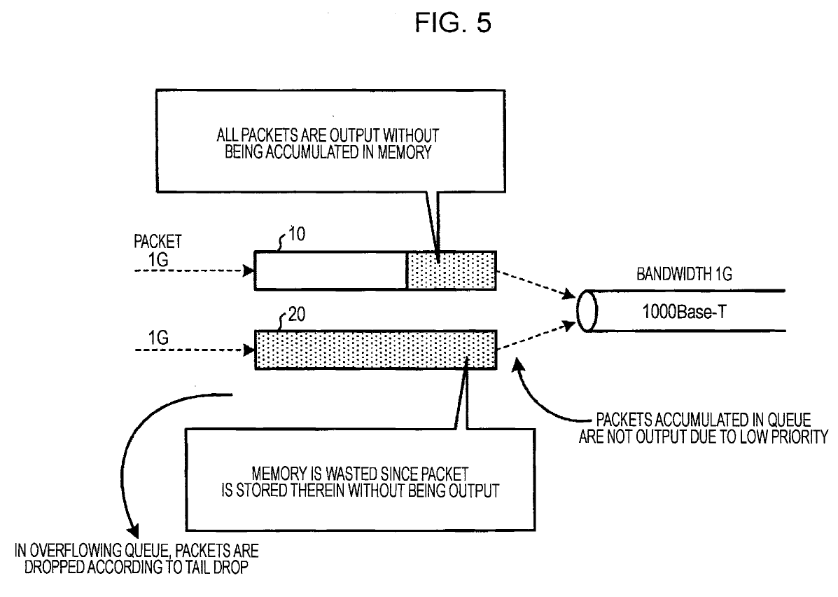

Since an extra buffering area for accepting burst-input packets has to be prepared when the maximum queue length is set, the queue may have an extra memory area. FIG. 5 is a diagram showing an example of an operation performed in queues having extra memory capacities.

In the example shown in FIG. 5, both of two queues 10 and 20 have extra memory areas. The priorities of the queues 10 and 20 are 7 and 1, respectively. Since extra memory areas are allocated, the queue 10 guarantees 1-Gbps (gigabit per second) performance even if the memory capacities of the queues 10 and 20 are reduced. In addition, as the queue 20 undergoes the tail drop operation, the operation on packets and the performance do not change. More specifically, in this example, the queue setting information or the like is monitored in realtime basis, and the set maximum queue length can be reduced according to the circumstances. Reduction and merger of queues permit effective utilization of the buffer memory 122. A relationship between a priority of the queues and a manner of outputting packets will be described. In the queue 10 with the priority of 7, all packets are output without being accumulated in the queue 10. On the other hand, in the queue 20 with the priority of 1, the memory area is wasted since packets are stored in the queue and are not output. That is, the packets accumulated in the queue 20 are not output due to the low priority.

In the embodiment, the QoS management unit 125 regularly monitors various kinds of setting data, i.e., the maximum queue length, the queue length, the priority, and the statistical information, that are registered in the queue management table shown in FIG. 2 by using a particular algorithm. The QoS management unit 125 calculates the queue optimization parameter shown in FIG. 3, and reduces or merges queues on the basis of the calculated queue optimization parameter.

Suppose that the usage ratio, the priority, and the bandwidth monitoring information of the queue optimization parameter for a queue having the queue number “n” (where “n” is an integer equal to or greater than 0) are X(n), Y(n), and Z(n), respectively.

1) The maximum queue length is compared with the actual queue length to calculate the usage ratio of the data area, namely, the usage ratio of the memory capacity. If the calculated usage ratio of the data area is equal to or larger than a predetermined value, the QoS management unit 125 considers that packets are accumulated in the queue and sets a flag for the usage ratio X(n). More specifically, the QoS management unit 125 stores 1 in a bit for the usage ratio X(n) in this embodiment. On the other hand, if the usage ratio of the data area is lower than the predetermined value, the QoS management unit 125 stores 0 in the bit for the usage ratio X(n).

2) The QoS management unit 125 sets a flag for the priority Y(n) if the priority of a queue is lower than a predetermined value. More specifically, the QoS management unit 125 stores 1 in a bit for the priority Y(n). On the other hand, the QoS management unit 125 stores 0 in the bit for the priority Y(n) if the priority of the queue is equal to or larger than the predetermined value.

3) The QoS management unit 125 monitors the statistical information and sets a flag for the bandwidth monitoring information Z(n) of a queue if a throughput of output packets of the queue is lower than a predetermined value. More specifically, the QoS management unit 125 stores 1 in a bit for the bandwidth monitoring information Z(n). On the other hand, the QoS management unit 125 stores 0 in the bit for the bandwidth monitoring information Z(n) if the throughput of output packets of the queue is equal to or higher than the predetermined value.

The QoS management unit 125 can perform a tuning operation on queues using the queue optimization parameter calculated at 1) to 3).

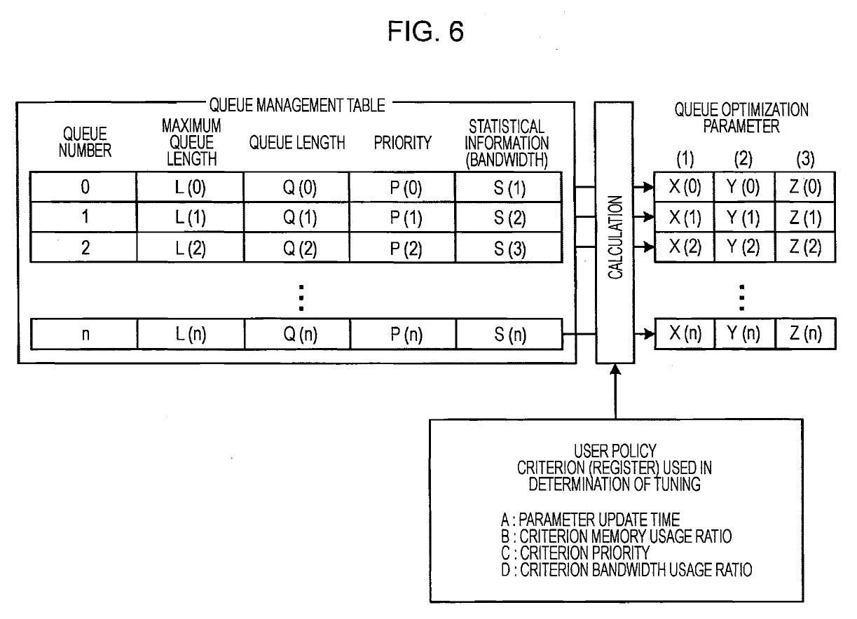

A method for calculating a queue optimization parameter will now be described. FIG. 6 is a diagram showing a calculation model of calculating a queue optimization parameter. As shown in FIG. 6, the router apparatus 100 has n queues. The maximum queue length, the actual queue length, the priority, and the throughput of a queue having the queue number n, which corresponds to the statistical information, are represented by L(n), Q(n), P(n), and S(n), respectively. Methods for calculating the usage ratio X(n), the priority Y(n), and the bandwidth monitoring information Z(n) under such a communication environment will be sequentially described.

### [Method for Calculating Usage Ratio X(n)]

An amount of used memory M(n) is successively calculated using an equation expressed as

M(n)=(L(n)−Q(n))/L(n).

However, since a calculation of the amount of memory used during a very short period of time makes a calculation error larger, an average amount of used memory, which is an average of a plurality of M(n) values, is calculated in this embodiment. More specifically, the average amount of used memory is determined as

M(n)=(ΣM(n)/A).

Meanwhile, users can freely set the value A.

For example, when the value A is set to 60, the value M(n) represents an average amount of used memory during 60 seconds. A routine coded as

“if M(n)>B then X(n)=1 else X(n)=0”

is executed on all of queues and a corresponding bit of the queue optimization parameter is set equal to 1 or 0. The value B in the above routine code represents a criterion regarding the memory usage ratio and can be freely set by users. Through this operation, queues having the high memory usage ratio and accumulated packets are registered as targets of a reduction or a merger.

### [Method for Calculating Priority Y(n)]

The priority of each queue is set in a register. Since the priority of the queue is stored and managed in the queue management table, the stored priority value is utilized. If the priority of the queue is lower than a value C, a corresponding bit of the queue optimization parameter is set to 1. Meanwhile, the value C is freely set by users. In this embodiment, a routine coded as

“if P(n)<C then Y(n)=1 else Y(n)=0”

is executed on all of queues. Through this operation, queues having the low priority are registered as targets of a reduction or a merger.

### [Method for Calculating Bandwidth Monitoring Information Z(n)]

A value S(n) is calculated from a difference between values of a statistical counter acquired by the statistical information monitoring unit 124 for each second. Meanwhile, the statistical counter is a counter that counts the lengths of transmitted packets. The value S(n) is calculated using an equation expressed as

S(n)=(difference between values of a byte counter for one second).

However, since a calculation of the value S(n) during a very short period of time makes a calculation error larger, an average bandwidth usage ratio, which is an average of a plurality of S(n) values, is calculated in this embodiment. More specifically, the average bandwidth usage ratio value is determined as

S(n)=(ΣS(n)/A).

For example, when the value A is set to 60, the value S(n) represents an average bandwidth usage ratio for 60 seconds. If the bandwidth usage ratio of a queue is lower than D% of a bandwidth of an output port, a corresponding bit of the queue optimization parameter is set to 1. Meanwhile, the value D can be freely set by users.

More specifically, a routine coded as

“if S(n)<TxPort(n)×(D/100) then Z(n)=1 else Z(n)=0”

is executed on all of queues using a maximum bandwidth value TxPort(n) of an output port assigned to a corresponding queue having the queue number n. Through this operation, queues having the low bandwidth usage ratio are registered as targets of a reduction or a merger.

The QoS management unit 125 refers to the queue optimization parameter of each queue and considers queues having the many flag-set bits as tuning-target queues. The tuning-target queues correspond to queues whose memory capacity may be reduced or queues that may be merged with other queues. In addition, the weight of each bit can be decided according to a user policy.

When a 1-bit error or a 2-bit error occurs in the buffer memory 122 during communication, or a transmission timeout error or a reception timeout error occurs, the QoS management unit 125 determines and separates a failed area. Since the separated area is an unusable memory area, the memory capacity of the buffer memory 122 reduces as a result.

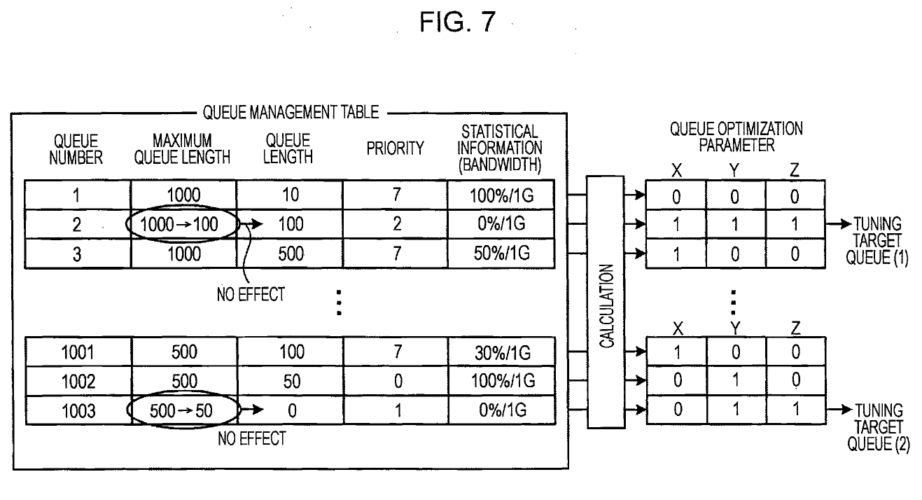

In such a case, the QoS management unit 125 reduces the maximum queue length of a queue having many flag-set bits in the queue optimization parameter. FIG. 7 is a diagram illustrating a reduction of memory capacities of queues. Referring to FIG. 7, a queue corresponding to the queue number “2” having a queue optimization parameter with many flag-set bits is focused on here, for example. Even if the maximum queue length of the queue “2” is reduced from “1000” to “100”, the reduction does not affect on the current operation state since the actually used queue length is “100”.

Similarly, a queue having the queue number “1003” will now be focused on. Even if the maximum queue length of the queue “1003” is reduced from “500” to “50”, the reduction does not affect on the current operation state since the actually used queue length is “0”. Accordingly, even if the maximum queue length of a tuning-target queue is reduced, the operation can be carried out with a minimum functional degradation.

Accordingly, the QoS management unit 125 can assign the reduced (freed) data area or the reduced (freed) memory capacity to a queue not having a sufficient data area, namely, a queue having a data area whose size is smaller than a predetermined value.

Additionally, a router apparatus having many queues can reduce the memory capacity by reducing the number of queues. More specifically, the QoS management unit 125 merges a plurality of queues having similar queue optimization parameters into one queue. Through this operation, a deficient queue memory capacity is supplemented.

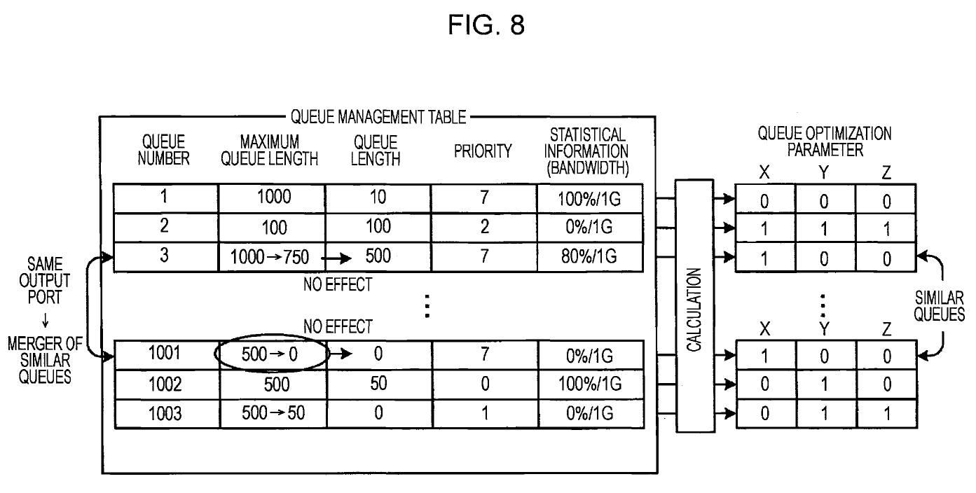

FIG. 8 is a diagram illustrating a merger of similar queues. In an example shown in FIG. 8, queues corresponding to the queue numbers “3” and “1001” have similar or identical queue optimization parameters.

Referring to FIG. 8, the maximum queue lengths of the queues “3” and “1001” are reduced by “250” and “500”, respectively. The queues “3” and “1001” are then merged into one queue having the maximum queue length of “750”. Through this operation, a memory capacity can be reduced by “750” in total and the reduced (freed) memory capacity can be assigned to a queue not having a sufficient memory capacity. A merger of similar queues is an effective method that allows a memory capacity to be reduced while suppressing the functional degradation than a merger of randomly selected queues.

A routine for a reduction or a merger of memory capacities according to the embodiment is executed in the following manner. More specifically, the QoS management unit 125 substitutes the values X(n), Y(n), and Z(n) of each queue into an equation expressed as

Q−OPT(n)=i×X(n)+j×Y(n)+k×Z(n).

A queue having a maximum (Q−OPT(n)) value, among all of queues, corresponds to a reduction-target queue. The values i, j, and k represent the weight of the values X(n), Y(n), and Z(n), respectively, and can be set freely by users.

The QoS management unit 125 checks the (Q−OPT(n)) values to determine whether or not the queue is a memory-reduction-target queue. More specifically, the determination routine is coded as

“lf((Q−OPT(n))>E) then L(n)=L(n)×F”.

The value E is a threshold for use in determination of whether or not to reduce the memory capacity. In addition, the value F sets a memory reduction ratio and is set to a decimal fraction between 0 and 1.

Suppose that the values are set as (Q−OPT(n))=5, E=4, F=0.5, and L(n)=1000, for example. At this time, since the value of (Q−OPT(n)) is greater than 4 ((Q−OPT(n))>4), the value L(n) is calculated as L(n)=1000×0.5=500. Accordingly, the maximum queue length L(n) is reduced from 1000 to 500, i.e., ½ of the original length.

If a memory-reduction-target queue does not exist, i.e., if the calculation result of (Q=OPT(n)) for all queues are equal to or smaller than E (Q−OPT(n)<E), the QoS management unit 125 merges similar queues.

In this case, the QoS management unit 125 detects a queue having the maximum (Q−OPT(n)) value and performs a matching operation on the detected queue and queues having the same output port as that of the detected queue. More specifically, the QoS management unit 125 retrieves a queue satisfying conditions of X(n)=X(m), Y(n)=Y(m), and Z(n)=Z(m). If a queue having the queue number “m” is found, the detected queue and the retrieved queue can be merged.

When merging the queues, the QoS management unit 125 recalculates the maximum queue length L(n) of the queue “n” and the maximum queue length L(m) of the queue “m”. More specifically, a routine for calculating the maximum queue length is coded as

“L(n)=(L(n)+L(m))×K, L(m)=0”.

The value K represents a reduction ratio of the maximum queue length and is set freely by users. The value K functions in a manner similar to the value F used in the memory reduction operation. In the example shown in FIG. 8, queues having the queue numbers “3” and “1001” are targets of the merger. The maximum queue length L(3) of the queue “3” is equal to 1000, whereas the maximum queue length L(1001) of the queue “1001” is equal to 500. Here, when K is set equal to 0.5, L(3) is calculated as L(3)=(L(3)+L(1001))×K=(1000+500)×0.5=750. As a result, the value L(1001) is merged into the value L(3) and becomes equal to 0, whereas the value L(3) is merged into the value L(1001) and becomes equal to 750. In this case, since the memory capacity is reduced by 750 through the merger of L(3) and L(1001), the reduced (freed) memory capacity of 750 can be assigned to another queue not having a sufficient memory capacity.

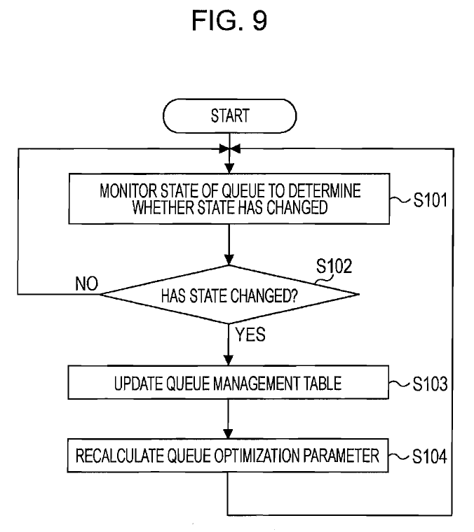

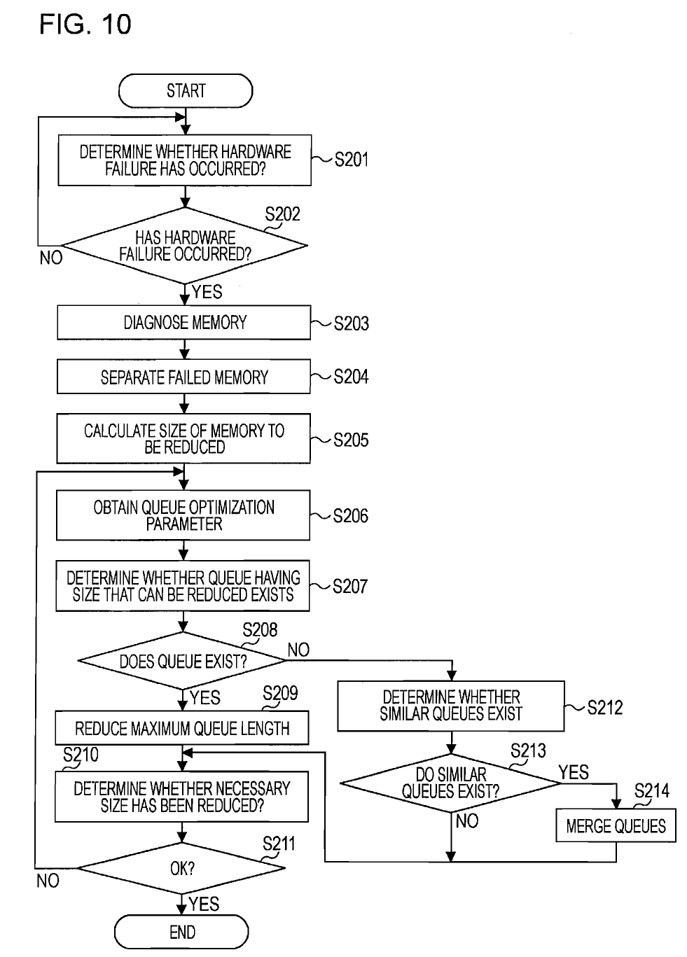

Procedures performed by the QoS management unit 125 according to an embodiment will now be described with reference to FIGS. 9 and 10. FIG. 9 is a flowchart showing a queue optimization parameter recalculation process performed by the QoS management unit 125 according to the embodiment. FIG. 10 is a flowchart showing a memory supplementation process performed by the QoS management unit 125 according to the embodiment. The QoS management unit 125 executes the processes shown in FIGS. 9 and 10 in parallel.

The process shown in FIG. 9 will be described first. The QoS management unit 125 monitors a state of queues allocated in the buffer memory 122 and determines whether or not the state of queues has changed (S101). If the QoS management unit 125 determines that the state of queues has not changed (NO of S102), the process returns to S101.

On the other hand, if the QoS management unit 125 determines that the state of queues has changed (YES of S102), the QoS management unit 125 updates the queue management table (S103). The QoS management unit 125 then recalculates the queue optimization parameter on the basis of the updated queue management table (S104). The process then returns to S101.

The process shown in FIG. 10 will now be described. The QoS management unit 125 determines whether or not a failure has occurred in hardware, such as, for example, the buffer memory 122 (S201). If the QoS management unit 125 determines that the failure has not occurred (NO of S202), the process returns to S201.

On the other hand, the QoS management unit 125 determines the failure has occurred (YES of S202), the QoS management unit 125 diagnoses the buffer memory 122 (S203). The QoS management unit 125 separates a failed memory area on the basis of the diagnosis result of the buffer memory 122 (S204).

The QoS management unit 125 calculates a memory capacity to be reduced, namely, a memory capacity to be assigned to another queue not having a sufficient memory capacity (S205). The QoS management unit 125 then obtains the queue optimization parameter (S206). More specifically, at S206, the QoS management unit 125 obtains the queue optimization parameter recalculated at S104 shown in FIG. 9. When the failure has occurred but the data area assigned to the queue is equal to or greater than a threshold, the memory capacity does not have to be supplemented. In this case, at S206, the QoS management unit 125 brings the process back to S201.

Subsequently, the QoS management unit 125 determines whether or not a memory-reduction-target queue exists (S207). If the QoS management unit 125 determines that the memory-reduction-target queue exists (YES of S208), the QoS management unit 125 reduces the maximum queue length of the queue (S209). The QoS management unit 125 then determines whether or not the necessary memory capacity is reduced through the reduction of the maximum queue length (S210). If the necessary memory capacity is reduced through the reduction of the maximum queue length (YES of S211), the QoS management unit 125 terminates the process. If the necessary memory capacity is not reduced (NO of S211), the process returns to S206.

On the other hand, if the memory-reduction-target queue does not exist (NO of S208), the QoS management unit 125 determines whether or not similar queues exist (S212). If the similar queues exist (YES of S213), the QoS management unit 125 merges these similar queues (S214). The process then proceeds to S210. On the other hand, if the similar queues do not exist (NO of S213), the process directly proceeds to S210.

In this mariner, the QoS management unit 125 calculates a memory capacity to be supplemented when a hardware failure has occurred. To obtain the necessary memory capacity, the QoS management unit 125 reduces the memory capacity of another queue or merges other queues on the basis of the queue optimization parameter. Therefore, according to the embodiment, the router apparatus 100 can continue a transmission operation without halting its operations.

As described above, when a failure has occurred in the buffer memory 122, the QoS management unit 125 of the router apparatus 100 according to the embodiment determines whether or not an usable memory capacity assigned to a queue is equal to or greater than a threshold, i.e., whether or not the memory capacity becomes deficient due to the occurrence of the failure. Based on the determination result, the QoS management unit 125 dynamically supplements the deficient memory capacity of the queue whose data area is less than the threshold with a data area of another queue. Thus, even if an unusable data area is caused, the embodiment allows hardware to continuously operate with minimum degradation and functional restriction resulting from an internal configuration change, which permits manufacture of more reliable apparatuses.

All of or some of processes having been described to be executed automatically, among those described in the embodiments, may be executed manually. Additionally, all of or some of processes having been described to be executed manually may be executed automatically. In addition, procedures, control procedures, specific names, information including various kinds of data and parameters shown herein and in the drawings can be freely changed unless otherwise noted.

In addition, the configuration of the router apparatus 100 shown in FIG. 1 is functional and conceptual, and the apparatus does not have to be physically configured as shown in the drawings. That is, specific configurations regarding distribution and integration of each apparatus is not limited to the ones shown in the drawings, and all of or some of configurations can be functionally or physically distributed or integrated in a given unit according to the various kinds of load and the usage status. Furthermore, all of or some of processing functions performed in each apparatus can be realized by a CPU (or, an MCU or an MPU), by a program that is analyzed and executed by the CPU, or by hardware employing the wired logic.

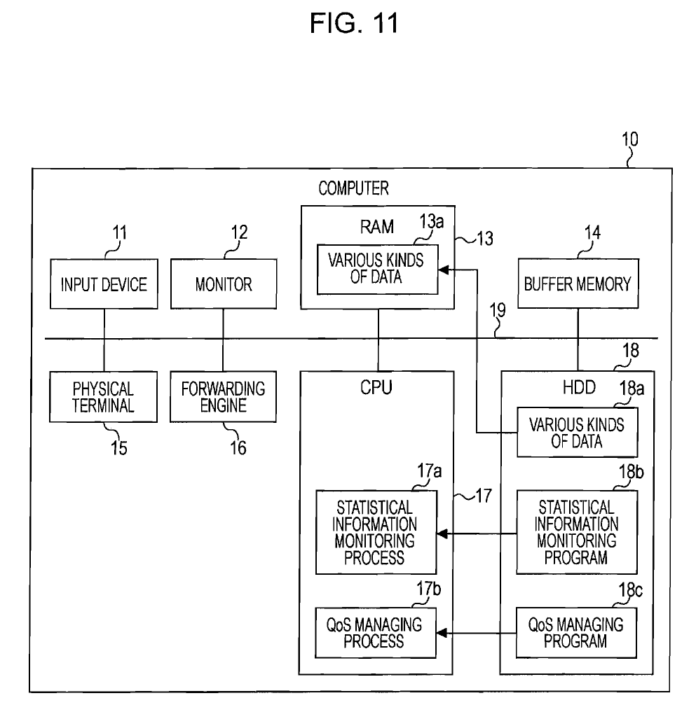

FIG. 11 is a diagram showing a hardware configuration of a computer installed in the line blade 120 shown in FIG. 1. A computer 10 includes an input device 11 for receiving data input from users, a monitor 12, a random access memory (RAM) 13, a buffer memory 14, a physical interface 15 for performing packet communication with an external apparatus, a forwarding engine 16 for performing packet communication with the main device 110, a central processing unit (CPU) 17, and a hard disk drive (HDD) 18, which are connected to each other through a bus 19.

The HDD 18 stores statistical information monitoring program 18b and a QoS management program 18c that demonstrate functions similar to those of the above-described line blade 120. The CPU 17 reads out the statistical information monitoring program 18b and the QoS management program 18c from the HDD 18 and executes these programs, thereby activating a statistical information monitoring process 17a and a QoS management process 17b that realize functions of the above-described functional units of the line blade 120. The statistical information monitoring process 17a and the QoS management process 17b correspond to the statistical information monitoring unit 124 and the QoS management unit 125 shown in FIG. 1, respectively.

The HDD 18 also stores various kinds of data 18a, which correspond to data stored in the above-described line blade 120. The various kinds of data 18a include the queue management table shown in FIG. 2 and the queue optimization parameter shown in FIG. 3.

The CPU 17 stores the various kinds of data 18a in the HDD 18. The CPU 17 also reads out the various kinds of data 18a from the HDD 18 and stores the read out various kinds of data 18a in the RAM 13. The CPU 17 performs various queue management operations using various kinds of data 13a stored in the RAM 13.

As described above, the router apparatus according to the embodiment is useful as a router for performing packet transmission. In particular, the router apparatus according to the embodiment is suitable for a case where a measure for the failure has to be taken without halting the router apparatus when a failure has occurred in a memory for storing packets and a memory capacity assigned to a queue becomes deficient.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of transmission communication media includes a carrier-wave signal.

Further, according to an aspect of the embodiments of the invention, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A router apparatus that allocates one or more queues in a storage device and transmits transmission-target data after temporarily storing the transmission-target data in the queue, the router apparatus comprising:
a determining unit determining a queue is a supplementation-target queue based upon whether size of a usable data area assigned to the queue is equal to or greater than a threshold; and
a supplementing unit supplementing the usable data area of the supplementation-target queue having the usable data area whose size is smaller than the threshold with a data area of a queue other than the supplementation-target queue.

2. The apparatus according to claim 1, wherein, when an error occurs in the storage device, the determining unit determines whether the size of the usable data area assigned to the queue becomes equal to or greater than the threshold in response to the occurrence of the error.

3. The apparatus according to claim 1, wherein the supplementing unit:
detects a reduction-target queue whose data area is to be reduced based upon a usage ratio of a data area of a queue, a priority of the queue, or a bandwidth usage ratio of the queue, or any combinations thereof,
reduces the data area of the detected reduction-target queue, and
assigns the reduced data area to the supplementation-target queue.

4. The apparatus according to claim 1, wherein the supplementing unit:
detects a plurality of reduction-target queues whose data areas are to be reduced based upon a usage ratio of a data area of a queue, a priority of the queue, or a bandwidth usage ratio of the queue, or any combinations thereof,
merges the data areas of the detected reduction-target queues, and
assigns a data area resulting from the merger to the supplementation-target queue.

5. The apparatus according to claim 4, wherein the supplementing unit merges the data areas of the detected reduction-target queues having a similar characteristic.

6. A queue supplementing method for a router apparatus that allocates one or more queues in a storage device and transmits transmission-target data after temporarily storing the transmission-target data in the queue, the method comprising:
determining a queue is a supplementation-target queue based upon whether size of a usable data area assigned to the queue is equal to or greater than a threshold; and
supplementing the usable data area of the supplementation-target queue having the usable data area whose size is smaller than the threshold with a data area of a queue other than the supplementation-target queue.

7. The method according to claim 6, further comprising:
determining, when an error occurs in the storage device, whether the size of the usable data area assigned to the queue becomes equal to or greater than the threshold in response to the occurrence of the error.

8. The method according to claim 6, further comprising:
detecting a reduction-target queue whose data area is to be reduced based upon a usage ratio of a data area of a queue, a priority of the queue, or a bandwidth usage ratio of the queue, or any combinations thereof,
reducing the data area of the detected reduction-target queue, and
assigning the reduced data area to the supplementation-target queue.

9. The method according to claim 6, further comprising:
detecting a plurality of reduction-target queues whose data areas are to be reduced based upon a usage ratio of a data area of a queue, a priority of the queue, or a bandwidth usage ratio of the queue, or any combinations thereof,
merging the data areas of the detected reduction-target queues, and
assigning a data area resulting from the merger to the supplementation-target queue.

10. The method according to claim 9, further comprising merging the data areas of the detected reduction-target queues having a similar characteristic.

11. A router apparatus that allocates one or more queues in a storage device and transmits transmission-target data after temporarily storing the transmission-target data in the queue, the router apparatus comprising:
a controller
determining a queue is a supplementation-target queue based upon whether size of a data area assigned to the queue is equal to or greater than a threshold; and
supplementing the usable data area of the supplementation-target queue having the data area whose size is smaller than the threshold with a data area of a queue other than the supplementation-target queue.

12. The router apparatus according to claim 11, wherein the controller further:
detects one or more reduction-target queues whose data areas are to be reduced based upon a usage ratio of a data area of a queue, a priority of the queue, or a bandwidth usage ratio of the queue, or any combinations thereof,
reduces and/or merges one or more of the data areas of the detected reduction-target queues, and
assigns a data area resulting from the reduced data area and/or from the merger to the supplementation-target queue.
